(19) United States
(12) Patent Application Publication
(10) Pub. No.: US 2011/0151189 A1
(43) Pub. Date: Jun. 23, 2011

(54) SHELL AND ELECTRONIC DEVICE HAVING THE SAME

(76) Inventors: Bing Zhang, Shenzhen (CN); Feng Cheng, Shenzhen (CN)

(21) Appl. No.: 13/060,462

(22) PCT Filed: Jul. 24, 2009
(86) PCT No.: PCT/CN2009/072918

§ 371 Date: Feb. 24, 2011

(30) Foreign Application Priority Data
Aug. 27, 2008 (CN) 200820147068.2

(51) Int. Cl. B32B 3/00; B32B 37/16

(52) U.S. Cl. 428/142; 156/242

(57) ABSTRACT

A shell is provided. The shell includes a substrate, a first pattern layer provided on an upper surface of said substrate, and a first transparent protection layer provided on an upper surface of said first pattern layer. The shell also includes a second pattern layer provided on a lower surface of said substrate, and a second transparent protection layer provided on a lower surface of said second pattern layer.

### TECHNICAL FIELD OF THE INVENTION

The present invention relates to a shell and an electronic device using the same.

### BACKGROUND OF THE INVENTION

At present, most shells of electronic devices such as a cell phone, a computer, a MP3 and so on are usually made of plastic material. And most of the plastic devices are decorated by spraying or electroplating. For these shells, after using for some time, the paint may flake off caused by impact, falling off and so on, which affects the appearance of the electric devices. And touch feeling and comfortableness of the paint are not good with relatively simple color pattern, which may not meet the requirements of the customers. To obtain high quality pattern or the appearance of the colors, In-Mold Label (IML) is often used to manufacture the shells for the electronic devices. During the process of IML, a thin sheet printed ink is placed into a mould for injection molding. During injection molding, the thin sheet combines the melted plastic particles to form the shell of the device. The product thus formed has the following characteristics: a layer of hardened transparent layer is formed on a surface of the substrate, there is an ink pattern layer printed on the inner surface of the transparent layer. In this case, as the ink pattern is protected by the transparent layer, abrasion of the ink pattern can be avoided, so the product is friction resistant without color fading. Although the IML device has good quality and excellent appearance, the pattern types are limited due to the color and effect of the inks.

### SUMMARY OF THE INVENTION

The present invention is directed to solve at least one of the problems existing in the prior art. Thus, the present invention needs to provide a shell and an electric device having the shell, by which defects of plain decoration may be overcome with enhanced quality.

According to an aspect of the invention, a shell is provided, comprising a substrate, a first pattern layer provided on an upper surface of the substrate; and a first transparent protection layer provided on an upper surface of the first pattern layer. The shell further comprises a second pattern layer provided on a lower surface of the substrate and a second transparent protection layer provided on a lower surface of the second pattern layer.

According to another aspect of the invention, the shell further comprises a first adhering layer between the first pattern layer and the upper surface of the substrate and a second adhering layer between the second pattern layer and the lower surface of the substrate.

According to yet another aspect of the invention, the shell further comprises a first clear-ink layer between the first pattern layer and the first adhering layer and a second clear-ink layer between the second pattern layer and the second adhering layer.

Further, an electronic device having the shell described hereinabove is provided according to an embodiment of the invention.

For the shell provided in the present invention, the pattern layer and the transparent layer are provided respectively on both the upper and lower surfaces of the substrate. According to the present invention, the first pattern layer overlaps with the second pattern layer in perspective view, presenting a combined or overlapped pattern with manifold and gorgeous colors. Meanwhile, the transparent layers protect the covered pattern ink respectively and the quality is reliable accordingly.

### DESCRIPTION OF THE DRAWINGS

These and other aspects and advantages of the invention will become apparent and more readily appreciated from the following descriptions taken in conjunction with the drawings in which:

FIG. 1 shows a cross sectional view of a shell according to an embodiment of the invention.

FIG. 2 shows a perspective schematic view of a substrate according to an embodiment of the invention.

FIG. 3 shows a perspective schematic view of a first transparent protection layer with a pattern layer formed thereon according to an embodiment of the invention.

FIG. 4 shows a perspective schematic view of a second transparent protection layer with a pattern layer formed thereon according to an embodiment of the invention.

FIG. 5 shows a plan view of a shell according to an embodiment of the invention.

### DETAILED DESCRIPTION OF THE EMBODIMENT

Reference will now be made in detail to embodiments of the present invention. The embodiments described herein with reference to drawings are explanatory, illustrative, and used to generally understand the present invention. The embodiments shall not be construed to limit the scope of the present invention. The same or similar elements and the elements having same or similar functions are denoted by like reference numerals throughout the descriptions. Further, in the entire and through description, relative terms such as “longitudinal”, “lateral”, “front”, “rear”, “right”, “left”, “lower”, “upper”, “horizontal”, “vertical”, “above”, “below”, “up”, “top”, “bottom” as well as derivative thereof shall be construed to refer to the orientation as then described or as shown in the drawings under discussion. These relative terms are for convenience of description and do not require that the present invention be constructed or operated in a particular orientation. Terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

Please also be noted that all numeric percentages mentioned hereinafter designate mass percentages generally unless otherwise stipulated.

The following will describe embodiment of the invention in conjunction with the accompanying figures.

According to an embodiment of the invention, a shell 100 is provided, comprising a substrate 1, a first pattern layer 3a provided on an upper surface of the substrate 1; a first transparent protection layer 2a provided on an upper surface of the first pattern layer 3a. The shell 100 further comprises a second pattern layer 3b provided on a lower surface of the substrate 1 and a second transparent protection layer 2b provided on a lower surface of the second pattern layer 3b.

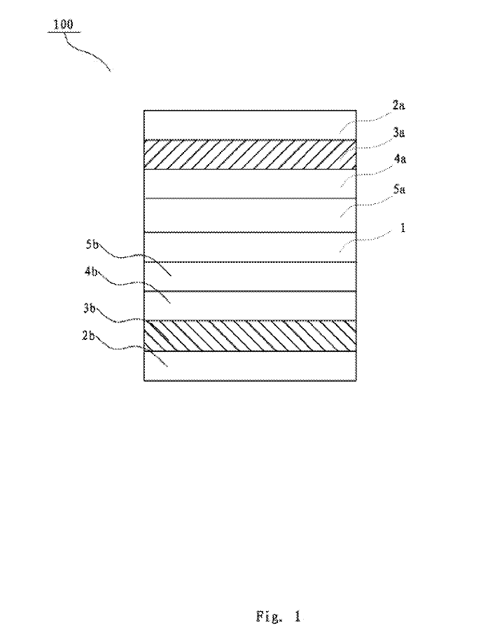

As shown in FIG. 1, the shell 100 provided according to the present embodiment comprises, from inside to outside of the shell 100 in sequence, the second transparent sheet 2b, the second pattern layer 3b, the second clear-ink layer 4b, the second adhering layer 5b, the substrate 1, the first adhering layer 5a, the first clear-ink layer 4a, the first pattern layer 3a, and the first transparent protection layer 2a.

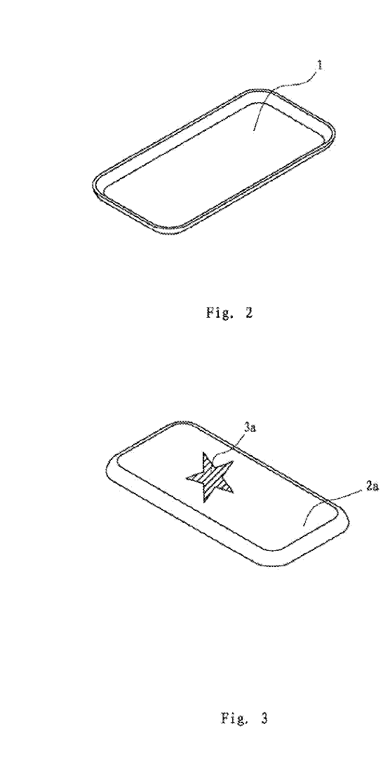

The substrate 1 according to the embodiment shown in FIG. 2 may be any transparent plastic substrate. For example, the conventional plastic material formed by injection molding, such as polyester, poly carbonate, acrylonitrile-butadiene-styrene (ABS), polymethyl methacrylate (PMMA), or the combination of at least two of them. The present embodiment employs poly carbonate (PC) as the plastic material for the substrate.

The transparent protection layer may be prepared from other materials, such as poly carbonate (PC), polyethylene terephthalate (PET), polymethyl methacrylate (PMMA) and so on. The present example employs PC material. A PC sheet has excellent molding and processing properties, also it has excellent surface finish and wear-resistance. The PC sheet adopted in the present invention is DMX smooth sheet from GE company.

Before molding the transparent sheet, the surface of PC sheet which contacts the substrate is formed, in sequence, with a printed-pattern layer, the clear-ink layer, and the adhering layer.

The pattern layer employs ink having high-temperature resistance, good adhering force, softness and high soften point. The pattern may be fully coated or partly coated on the surface of the PC sheet. The ink forms various patterns according to the decoration design and market requirement. The pattern may be one or the combination of at least two of the basic color blue, green and red thus to achieve different visual effect. The present embodiment employs N2K series ink from Germany PROELL Co., Ltd, the diluter employs N2K097-003, dosage is 15%; the hardener employs N2K005, dosage is 3%, the above materials are then mixed to obtain the ink. The printing method is screen printing: colored polyester silk screen of 150-300 mesh/cm and solvent resistant photosensitive coating are employed. The printer is conventional printer, the printing method is known in the art and the detailed description thereof is omitted hereby for clarity purpose. The PC sheet with printed ink is put into the oven and is baked at 80° C. for 30 minutes so that the solvent is fully volatilized and dried.

The clear-ink layers and the adhering layers are used to protect the ink of the pattern layers so that the pattern would not get injured during the subsequent processing. Meanwhile, the clear-ink layers and the adhering layers will coordinate and increase the adhering force of the pattern layers and the substrate. The clear-ink layer employs N2K093 transparent varnish distributed by PROELL Co., Ltd, Germany, and it is molded by printing. Before printing, it is ensured the PC sheet attached with the pattern layer is clean, otherwise the dirt on the surface will cause chromatic aberration or bubbles etc. The printing device and the method are the same as those utilized in the pattern printing process. The adhering layer employs aqueous adhesive agent Aquapress ME distributed by PROELL Co., Ltd, Germany, the printing device and the printing method are the same as those used in the above mentioned clear-ink layer printing process. The bubbles caused by the high viscosity of the adhesive agent during printing may be solved by adding antifoaming agent with dosage normally not more than 0.5%. To cooperate with the whole process, in an embodiment of the invention, the adhesive agent is printed by three times, the printed adhering layer is dried each time after printing. Each time of printing, the quality is ensured to prevent chromatic aberration, impurities and bubbles.

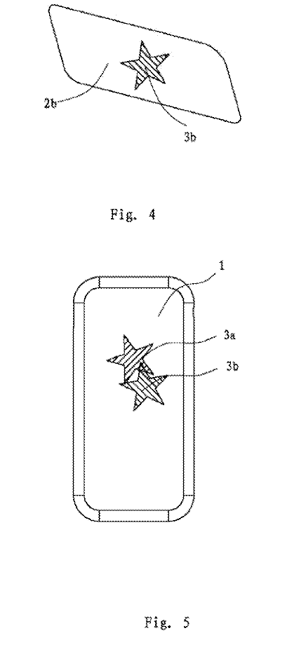

The PC sheet after the above treatment is then molded. According to an embodiment of the invention, the flat PC sheet is formed as the transparent protection layer 2a as shown in FIG. 2 which matches the upper surface of the substrate 1 and the transparent protection layer 2b as shown in FIG. 4 which matches the lower surface of the substrate 1. The transparent protection layers 2a and 2b in the example embodiment are respectively formed by high pressure molding and thermal pressing molding. For the transparent protection layer 2a, high pressure molding is employed, which uses air pressure to mold the preheated PC sheet in a metal mould. During the molding process, the temperature, pressure and pressure holding time shall be controlled as process may require. In an embodiment of the invention, LFORM100-A high pressure forming machine is used as the high pressure molding device. And the preheating time is 15 seconds, the low pressure is 10 Kg/cm², the low pressure holding time is 4 seconds, the high pressure is 20 Kg/cm², the high pressure holding time is 6 seconds, and the pressure relief time is 5 seconds, the upper mould temperature is 125° C., the lower mould temperature is 115° C. For the transparent protection layer 2b, the molding device is pneumatic hot pressing device and the type is RYCX-15T-LA. The mould temperature is 120° C. The pressure is 15 Kg/cm², and the pressure holding time is 20 seconds. Mold press forming has very strict requirements with the design and manufacture of the mould. The forming mould and the injection mould shall have mated cavities, the shape and dimension error of both moulds shall have very high processing precision. Sharp angle transition shall be avoided. Arc is used in the transitions. The high pressure molding and thermal pressing molding are known in the art, therefore, the detailed description thereof is hereby omitted for clarity purpose. After molding, the PC sheet is placed into the punching mould for cutting off the waste edges such that the shape of the sheet is totally mated with the required shape of the external and inner surfaces of the shell 100. The punching device is four-pillar hydraulic punching machine with model type of KT108, the punching pressure is 6 Kg/cm² and the cycle is 1.2 s. The detailed punching process is known in the art, therefore, the detailed description thereof is hereby omitted for clarity purpose.

The formed transparent protection layer 2a and the transparent protection layer 2b are placed into the injection mould to be opposite to each other. The injection mould comprises at least two molding boards which can precisely position the transparent protection layers. The punched transparent protection layer 2a and transparent protection layer 2b are positioned respectively on two boards by structure locating, electrostatic adsorption or vacuum adsorption. The board which positions the transparent protection layer 2a is a female mould, the board which positions the transparent layer 2b is a male mould. After placing the transparent protection layer 2a and the transparent protection layer 2b into the injection mould, the PC injection material is injected between the two transparent layers 2a, 2b so that the injection material and the transparent layers are bonded together. According to an embodiment of the invention, the injection material used is PC X7300/CL of SABIC with the injection temperature of about 260-280° C. The injection molding method is known in the art, for example, Hai Tian 100-Ton injection machine may be used. The obtained device is shown as FIG. 5.

In the shell 100 according to the present invention, the thickness of the formed transparent protection layers 2a, 2b are 0.1-0.3 mm, respectively. In an embodiment of the invention, the thickness thereof is 0.1-0.2 mm. The thickness of the pattern layers 3a, 3b is about 20-40 um, in an embodiment of the invention, the thickness thereof is 25-35 um. The thickness of the formed clear-ink layers 4a, 4b is about 15-40 um. In an embodiment of the invention, the thickness thereof is 15-25 um. Further, the thickness of the formed adhering layers 5a, 5b is about 15-100 um. In an embodiment of the invention, the thickness thereof is 20-70 um.

The shell 100 provided in the present invention has excellent adhesive force, scratch resistance and vibration wear resistance, the details will be described in the following.

For example, the adhering force hundred grids test (Erichsen Cross Hatch Cutter Model 295, soft brush, and adhesive tape that meet the ISO 2409 standard, eg. Elcometer Adhesive Tape Part No.T1079358) shows that the testing result reaches 0 level which is the best in the classified five levels, i.e., 0 level, first level, second level, third level, fourth level and fifth level. The testing method is known in the art, thus the detailed description thereof is hereby omitted for clarity purpose.

Further, experiments show that the scratch resistance of the shell 100 reaches 2N with the testing machine of Erichsen model 318. Because the testing method is known in the art, thus the detailed description thereof is hereby omitted for clarity purpose.

Still further, experiments, using, for example, Rosler Trough Vibrator with wearing medium of Rosler wearing particles RKF 10K, Rosler wearing particles RKK 15P and Rosler wash FC 120, show that the vibration wear resistance of the shell 100 can endure 2 hours, which is basically required to be higher than 1.5 hours. In these experiments, the standard thereof is regulated as the damaged area of the shell 100 exceeding 1 mm×1 mm.

The present invention further provided an electronic device (not shown), the electronic device may comprise a main body and a shell for enclosing the main body, the shell thereof is the shell 100 provided in the present invention.

The main body comprises multiple components that can realize the device function, such as communication function or decoration function etc. Further, the components and connections are known in the art, thus the detailed description thereof is hereby omitted for clarity purpose.

Please be noted that the electronic device may be those currently used ones such as a mobile phone, a MP3 player, a PDA, a laptop computer, a digital camera and so on. However, these examples are shown only for illustration purpose rather than limitation.

Although explanatory embodiments have been shown and described, it would be appreciated by those skilled in the art that changes, alternatives, and modifications can be made in the embodiments without departing from spirit and principles of the invention. Such changes, alternatives, and modifications all fall into the scope of the claims and their equivalents.

1. A shell comprising:
a substrate;
a first pattern layer provided on an upper surface of said substrate;
a first transparent protection layer provided on an upper surface of said first pattern layer;
a second pattern layer provided on a lower surface of said substrate; and
a second transparent protection layer provided on a lower surface of said second pattern layer.

2. The shell according to claim 1, wherein said shell further comprises a first adhering layer between said first pattern layer and said upper surface of the substrate.

3. The shell according to claim 2, wherein said shell further comprises a second adhering layer between said second pattern layer and said lower surface of the substrate.

4. The shell according to claim 3, wherein said shell further comprises a first clear-ink layer between said first pattern layer and said first adhering layer.

5. The shell according to claim 4, wherein said shell further comprises a second clear-ink layer between said second pattern layer and said second adhering layer.

6. The shell according to claim 5, wherein said first and second adhering layers have a thickness of about 15-100 um respectively.

7. The shell according to claim 1, wherein said first and second pattern layers have a thickness of about 20-40 um respectively.

8. The shell according to claim 5, wherein said first and second adhering layers have a thickness of about 20-70 um respectively.

9. The shell according to claim 1, wherein said first and second pattern layers have a thickness of about 25-35 um respectively.

10. An electronic device having the shell according to claim 1.

11. The shell according to claim 6, wherein said first and second clear-ink layers have a thickness of about 15-40 um respectively.

12. The shell according to claim 5, wherein said first and second clear-ink layers have a thickness of about 15-40 um respectively.

13. The shell according to claim 7, wherein said first and second transparent protection layers have a thickness of about 0.1-0.3 mm respectively.

14. The shell according to claim 1, wherein said first and second transparent protection layers have a thickness of about 0.1-0.3 mm respectively.

15. The shell according to claim 8, wherein said first and second clear-ink layers have a thickness of about 15-25 um respectively.

16. The shell according to claim 5, wherein said first and second clear-ink layers have a thickness of about 15-25 um respectively.

17. The shell according to claim 9, wherein said first and second transparent protection layers have a thickness of about 0.1-0.2 mm respectively.

18. The shell according to claim 1, wherein said first and second transparent protection layers have a thickness of about 0.1-0.2 mm respectively.

19. A method of forming a shell, comprising:
providing a first and a second transparent protection sheet;
forming, on a surface of each of the first and the second transparent protection sheets, in sequence, a printed-pattern layer, a clear-ink layer, and an adhering layer;
molding the first and the second transparent protection sheets into a first and a second transparent protection layer, respectively;
positioning the first and the second transparent protection layers with the respective adhering layers facing one another; and
injecting a substrate material between the first and second transparent protection layers.

20. The method according to claim 19, wherein molding the first and the second transparent protection sheets includes molding the first and the second transparent protection sheets using at least one of a high pressure molding and a thermal pressing molding.
